(19) United States
(12) Patent Application Publication
(10) Pub. No.: US 2015/0288735 A1
(43) Pub. Date: Oct. 8, 2015

(54) Virtual Audio Device System for Unified Communications Applications

(71) Applicant: ClearOne Inc., Salt Lake City, UT (US)

(72) Inventors: Balasubramaniyan Krishnamoorthy, Salt Lake City, UT (US); Peter H. Manley, Draper, UT (US); Derek Graham, South Jordan, UT (US)

(73) Assignee: CLEARONE INC., Salt Lake City, UT (US)

(21) Appl. No.: 14/678,954

(22) Filed: Apr. 4, 2015

Related U.S. Application Data
(60) Provisional application No. 61/975,409, filed on Apr. 4, 2014.

(51) Int. Cl. H04L 29/06; G06F 3/16

(52) U.S. Cl. CPC H04L 65/602; G06F 3/165

(57) ABSTRACT

This disclosure describes a system that uses a virtual audio device system for unified communications (UC) applications between a host device and a plurality of audio devices (100, 130), which includes a host device (108), a plurality of audio devices (104, 106), and a virtual audio device system (124). The host device (108) executes a Unified Communications (UC) application (114) to generate a first audio data stream. The host device (108) is in communication with a microphone (110) and a speaker (112). The plurality of audio devices (104, 106) receive the first audio data stream generated by the host device, where each of the plurality of audio devices (104, 106) generates its own audio data stream. Further, the virtual audio device system (124) establishes a communication channel between the UC application (114) and the plurality of audio devices (104, 106) based on the plurality of audio devices (104, 106) connected to the host device (108). And, the virtual audio device system (124) is configured to combine the first audio data stream and the additional audio data streams to create a composite audio data stream.

### CROSS REFERENCE TO RELATED APPLICATIONS

This application claims priority and the benefits of the earlier filed Provisional U.S. A No. 61/975,409, filed 4 Apr. 2014, which is incorporated by reference for all purposes into this specification.

### TECHNICAL FIELD

This disclosure relates to Unified Communications (UC) systems. More specifically, this disclosure relates to a virtual audio device system for Unified Communications.

### BACKGROUND ART

Several Unified Communications (UC) software applications have proliferated into the enterprise communications market. These applications allow end-users to communicate using voice, video, application and data sharing, instant messaging, etc.

Typically, a user is required to manually assign physical input and output (I/O) devices to the UC software applications for audio recording and playback. Audio signals from the assigned I/O devices are mapped to the UC applications by a local audio system of the operating system. One such local audio system is the Windows Audio System that is capable of mixing several audio data streams and playing a combined audio data stream from multiple sources to a single output device. However, the Windows Audio System does not have the capability of mixing audio data streams sent to a UC application from multiple audio recording devices and then play a single UC audio data stream or the combined audio data stream out to multiple audio output devices concurrently.

Therefore there exists a need for a system that allows a UC application to play an audio data stream via multiple output devices simultaneously.

### SUMMARY OF INVENTION

This disclosure describes a system that uses a virtual audio device system for unified communications (UC) applications between a host device and a plurality of audio devices. The system comprises a host device, a plurality of audio devices, and a virtual audio device system. The host device executes a UC application to generate a first audio data stream, wherein the host device is in communication with a microphone and a speaker. The plurality of audio devices receives the first audio data stream generated by the host device, wherein each of the plurality of audio devices is capable of generating its own additional audio data stream. The virtual audio device system establishes a communication channel between the UC application and the plurality of audio devices based on the plurality of audio devices connected to the host device. The virtual audio device system is configured to combine the first audio data stream and the additional audio data streams to create a composite audio data stream.

Another embodiment of this disclosure provides that the virtual audio device system dynamically adjusts the combining of the audio data streams into the composite audio data stream according to the absence or presence of the UC application and the plurality of audio devices connected to the host device.

Another embodiment of this disclosure provides that the plurality of audio devices comprise at least one of a mobile communication device and a speakerphone.

Another embodiment of this disclosure provides that the virtual audio device system is implemented as a device driver.

Another embodiment of this disclosure provides that the virtual audio device system is dynamically managed by a predefined software application such as a conference application, which controls the microphone and the speaker as default devices upon request.

Other and further aspects and features of the disclosure will be evident from reading the following detailed description of the embodiments, which are intended to illustrate, not limit, the present disclosure.

### BRIEF DESCRIPTION OF DRAWINGS

To further aid in understanding the disclosure, the attached drawings help illustrate specific features of the disclosure and the following is a brief description of the attached drawings:

FIG. 1A illustrates a first network environment for implementing an exemplary virtual audio device system, according to an embodiment of the present disclosure.

FIG. 1B illustrates a second network environment for implementing the virtual audio device system of FIG. 1A, according to an embodiment of the present disclosure.

FIG. 1C illustrates a third network environment for implementing the virtual audio device system of FIG. 1A, according to an embodiment of the present disclosure.

FIG. 1D illustrates a fourth network environment for implementing the virtual audio device system of FIG. 1A according to an embodiment of the present disclosure.

FIG. 2 illustrates the virtual audio device system of FIG. 1A, according to an embodiment of the present disclosure.

FIGS. 3A and 3B illustrate an exemplary virtual audio device stack implemented by the virtual audio device system of FIG. 1A, according to an embodiment of the present disclosure.

### DISCLOSURE OF EMBODIMENTS

This disclosure describes a virtual audio device system for Unified Communications. This disclosure describes numerous specific details in order to provide a thorough understanding of the present invention. One ordinarily skilled in the art will appreciate that one may practice the present invention without these specific details. Additionally, this disclosure does not describe some well-known items in detail in order not to obscure the present invention.

### NON-LIMITING DEFINITIONS

In various embodiments of the present disclosure, definitions of one or more terms that will be used in the document are provided below.

A “host device” is used in the present disclosure in the context of its broadest definition. The host device may refer to a networked computing device configured to at least one of (1) store, manage, or process audio, video, or alphanumeric data or documents, (2) establish a communication channel with or a communication environment for an external device, and (3) request services from or deliver services to, or both, other devices connected to the network. Various examples of the host device include, but not limited to, a desktop PC, a personal digital assistant (PDA), a server, a mainframe computer, a mobile computing device (e.g., laptops, etc.), etc.

An “endpoint” is used in the present disclosure in the context of its broadest definition. The endpoint may refer to one or more computing devices capable of establishing a communication channel for exchange of at least audio data streams in a communication session. Examples of the computing devices may include, but are not limited to, a desktop, laptop, notebook personal computer with included or built-in speakers and microphone, a personal digital assistant (PDA), a server, a mainframe computer, a mobile computing device (e.g., mobile phones, laptops, tablets, etc.), calling devices (e.g., a telephone, a speakerphone, an internet phone, a video telephone, etc.).

A “mobile communication device” is used in the present disclosure in the context of its broadest definition. The mobile communication device may refer to any of a variety of portable computing devices including a mobile phone, a tablet, a laptop, and so on, configured for or capable of providing audio data streams.

The numerous references in the disclosure to the virtual audio device system are intended to cover any and/or all devices capable of performing respective operations on the endpoints in a conferencing environment relevant to the applicable context, regardless of whether or not the same are specifically provided.

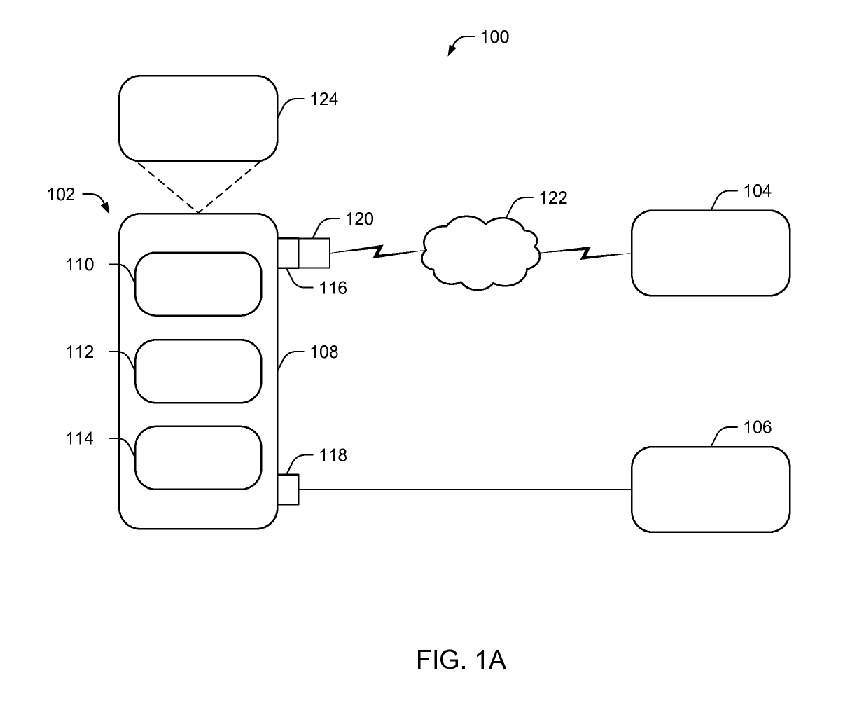

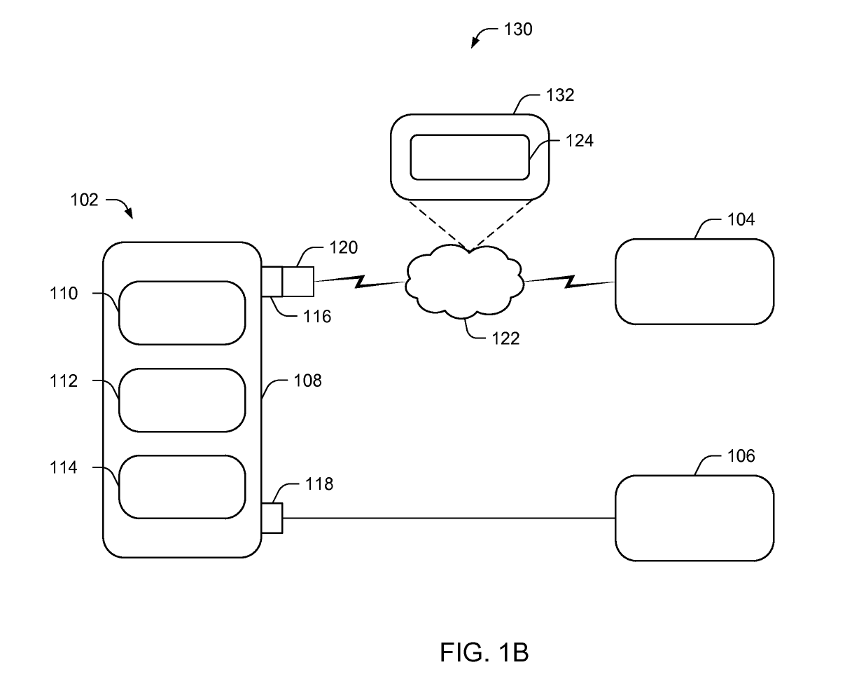

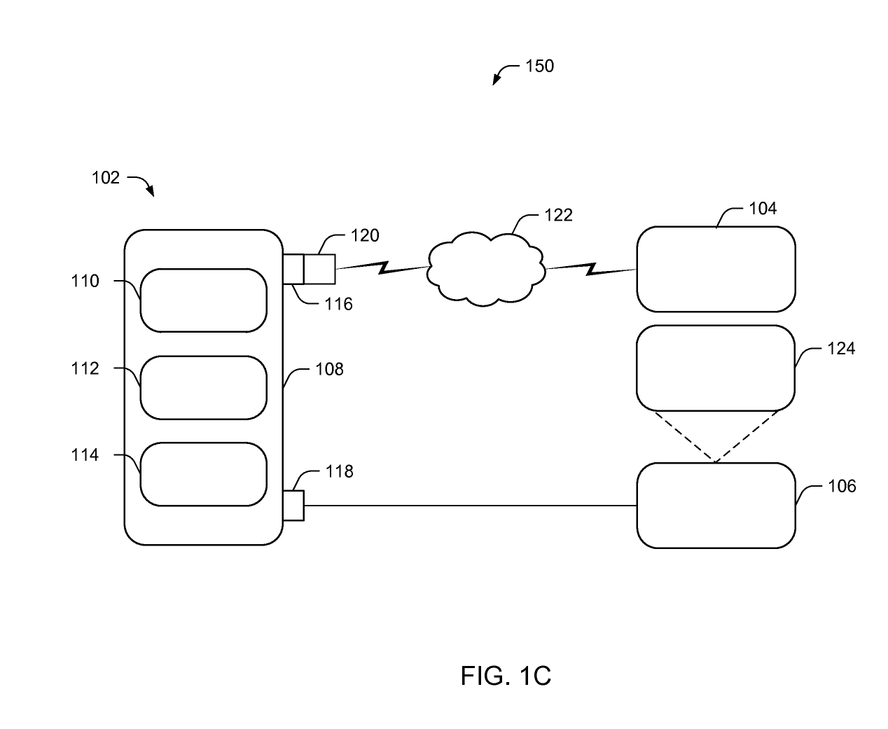

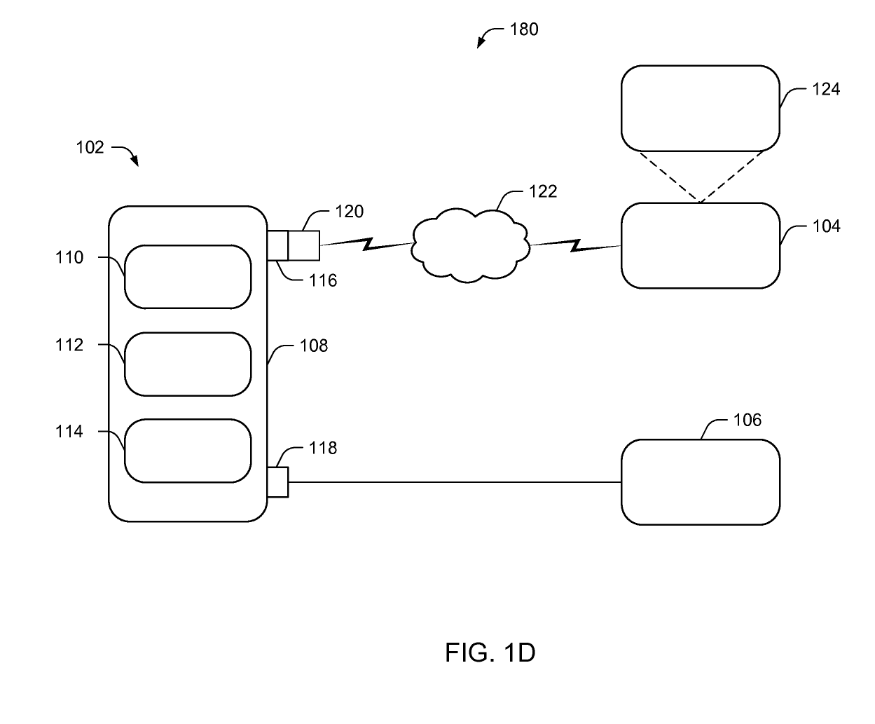

FIG. 1A illustrates a first network environment 100 for implementing an exemplary virtual audio device system according to an embodiment of the present disclosure. In this embodiment, the system is disclosed in the context of environments that represent an audio conference among multiple users via a UC application executed on a host device in communication with one or more audio sources such as a mobile communication device or an audio conference endpoint (AC endpoint). The UC application may receive audio data streams directly from users via a host device or from such audio sources. In some embodiments, the system may be applied in the context of other scenarios (e.g., a video conference) involving audio data streams being communicated to the UC application. In some embodiments, the UC application may be executed as a software application by the AC endpoint during a conference session.

The first network environment 100 may include a Unified Communications (UC) system 102, a mobile communication device 104 (e.g., a mobile phone), and an AC endpoint 106. The UC system 102 may include a computing device such as a host device 108 associated with hardware such as a host microphone 110 and a host speaker 112. In some embodiments, the host device 108 may comprise video, voice and data communication capabilities (e.g., videoconferencing capabilities) by being coupled to or including, various audio devices (e.g., audio input devices, audio output devices, telephones, speaker telephones, etc.), various video devices (e.g., monitors, projectors, displays, televisions, video output devices, video input devices, cameras, etc.), various networks (IP, PSTN, etc.) or any combination thereof, or any other type of conferencing hardware. In one embodiment, the host device 108 may be configured to host and/or execute UC software applications such as a UC application 114. The UC application may be various types of communication services including, but not limited to, instant messaging, chat application, data sharing application, audio conferencing, video conferencing, web conferencing, screen sharing, and the like. Each of the UC applications, such as the UC application 114, may operate with the same or different communication protocols and media formats. The UC application 114 may be configured to generate or receive multiple audio data streams or a single composite audio data stream.

The host device 108 may include one or more of a variety of interfaces known in the art, related art, or developed later including, but not limited to, a PC Card slot, a Peripheral Component Interconnect (PCI), and an Advanced Graphic Port (AGP) for being coupled to or communicate with one or more external devices. In one example, the host device 108 may include a first Universal Serial Bus (USB) port 116 and a second USB port 118. The first USB port 116 may be coupled to an external adaptor 120, which may be configured to communicate with the mobile communication device 104 over a short range wireless network 122 based on a predetermined communication protocol. In one example, the adaptor 120 may be a Bluetooth adaptor configured to communicate with the mobile communication device 104 such as a mobile phone based on a Bluetooth communication protocol over the network 122. In some embodiments, the adaptor 120 may communicate with the mobile communication device 104 through a Bluetooth-type audio communication channel, or in other words, a short range wireless communication channel, being established based on a variety of corresponding Bluetooth-type communication standards known in the art, related art, or developed later including Bluetooth, Wi-Fi, ZigBee, and Z-Wave. In other embodiments, the adaptor 120 may be integrated with the host device 108.

The short range wireless network 122 may include, for example, Wide Area Networks (WANs), Local Area Networks (LANs), Personal Area Networks (PANs), radio, television, and/or any other delivery or tunneling mechanism for carrying data such as audio data. The network 122 may comprise multiple networks or sub-networks, each of which may comprise, for example, a wireless data pathway. The network 122 may comprise a circuit-switched voice network, a packet-switched data network, or any other network 122 that is able to carry electronic communications. For example, the network 122 may comprise networks based on short range wireless communication protocols including, but not limited to, Bluetooth, ZigBee, Wi-Fi, ANT+, and Z-Wave. The network 122 may support voice using these protocols and other comparable protocols for voice data communications.

The connection between the adaptor 120 and the mobile communication device 104 may be managed using a dedicated Bluetooth profile such as the hands free profile (HFP), the headset profile (HSP), or the advanced audio distribution profile (A2DP), which may be defined by the Bluetooth communication protocol for allowing encoding and transmission of audio data between the mobile communication device 104 and the adaptor 120. In one example, the mobile communication device 104 may pair or connect with the adaptor 120 in the headset profile for communicating audio data streams as an audio peripheral such as a headset. In the headset profile, the mobile communication device 104 may be configured to receive audio data streams via the adaptor 120.

Further, the host device 108 may be coupled to the AC endpoint 106 through the second USB port 118 using a compatible transmission media such as a USB cable. The AC endpoint 106 may be removably connected to the host device 108 as a peripheral device. In one embodiment, the AC endpoint 106 may receive audio data streams from one or more sources such as the UC application 114 (or the host device 108) via the second USB port 118, or directly from a user. In another embodiment, the AC endpoint 106 may establish a communication channel with other locally or remotely located devices or endpoints such as AC endpoints over a network such as the Internet, analog or digital wired and wireless telephone networks (e.g., a PSTN, Integrated Services Digital Network (ISDN), a cellular network, and Digital Subscriber Line (xDSL)), satellite, and/or any other delivery or tunneling mechanism to send or receive audio data streams. In yet another embodiment, the AC endpoint 106 may store data from the received audio data streams.

The host device 108 may be installed, be integrated, or operate in communication with a virtual audio device system 124. In one embodiment, the virtual audio device system 124 may create a logical representation of one or more networked devices such as the mobile communication device 104 in communication with the host device 108. In another embodiment, the virtual audio device system 124 may detect one or more networked devices being connected or disconnected from the host device 108. In yet another embodiment, the virtual audio device system 124 may automatically link the UC application 114 to the connected multiple input or output devices simultaneously. In still another embodiment, the virtual audio device system 124 may establish a local communication channel among the mobile communication device 104, the AC endpoint 106, and the UC application 114 being executed by the host device 108. In a further embodiment, the virtual audio device system 124 may manage and process the audio data streams received from the AC endpoint 106, the UC application 114, and the mobile communication device 104. In some embodiments, the virtual audio device system 124 may request services from or deliver services to, or both, various devices connected to a network such as the network 122. In other embodiments, the virtual audio device system 124 may combine audio data streams from two or more audio sources such as the mobile communication device 104 (via the adaptor 120), one or more UC applications such as the UC application 114, and a peripheral device such as the AC endpoint 106 (via the second USB port 118) to create a composite audio data stream.

The virtual audio device system 124 may facilitate integration of real-time and non-real-time communication services by establishing an audio bridge or communication channel between the UC application 114 being executed on the host device 108 and multiple audio devices such as the mobile communication device 104 and the AC endpoint 106 simultaneously. Examples of such real-time services may comprise, but are not limited to, instant voice messaging, audio conferencing, call control, and speech recognition. Examples of the non-real-time services may comprise, but are not limited to, voicemail and audio short messaging service (audio SMS).

In some embodiments, the virtual audio device system 124 may be a standalone and dedicated device including hardware and installed software, where the hardware is compatible with the requirements and/or functionality of the software. Alternatively, the virtual audio device system 124 may be a software application or a device driver. The virtual audio device system 124 may enhance or increase the functionality and/or capacity of the network 122 to which it is connected.

In some other embodiments, the virtual audio device system 124 may be configured to expose its computing environment or operating code to the user, and may comprise related art input and output (I/O) devices, such as a microphone, a speaker, a camera, a scanner, a keyboard, or a display. The virtual audio device system 124 may, however, comprise software, firmware or other resources that support remote administration and/or maintenance of the virtual audio device system 124.

In yet another embodiment, the virtual audio device system 124 may comprise at least one processor (not shown) executing machine readable program instructions for performing various operations, such as those discussed above, on the received audio data streams. The virtual audio device system 124 may comprise, in whole or in part, a software application such as a conference application (discussed below in greater detail) working alone or in conjunction with one or more hardware resources such as the host device 108. Such software applications may be executed by the processor on different hardware platforms or emulated in a virtual environment. Aspects of the virtual audio device system 124 may leverage known, related art, or later developed off-the-shelf software.

Further, embodiments of the second network environment 130 (FIG. 1B) may include the virtual audio device system 124 being integrated with, or installed on, a network appliance 132 that is associated with or used to establish the network 122. The network appliance 132 may be capable of operating as an interface device to assist exchange of program instructions and audio data between the UC application 114 on the host device 108 and external audio devices such as the mobile communication device 104 and the AC endpoint 106. In some embodiments, the network appliance 132 may be preconfigured or dynamically configured to include the virtual audio device system 124 integrated with other devices. Other examples of network environments include: (1) a network environment 150 where the virtual audio device system 124 may be integrated with the AC endpoint 106 as illustrated in FIG. 1C; or (2) a network environment 180 where the virtual audio device system 124 may be integrated with any other device, such as the mobile communication device 104 that is connected to the network 122 and is illustrated in FIG. 1D. The virtual audio device system 124 may include a module (not shown), which may introduce the virtual audio device system 124 to the network appliance 132, thereby enabling the network appliance 132 to invoke the virtual audio device system 124 as a service. Examples of the network appliance 132 may comprise, but are not limited to, a DSL modem, a wireless access point, a router, and a gateway having a predetermined computing power sufficient for implementing the virtual audio device system 124.

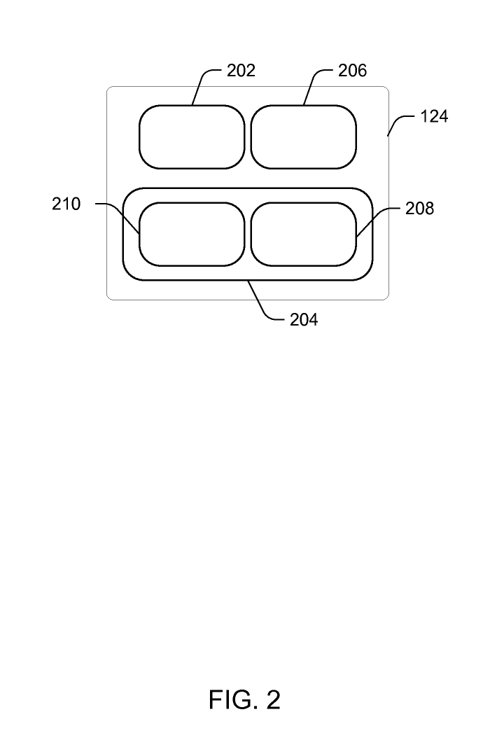

FIG. 2 illustrates the virtual audio device system of FIG. 1A according to an embodiment of the present disclosure. The virtual audio device system 124 may be implemented in a single device, as illustrated, or may be distributed across multiple devices. The virtual audio device system 124 may be implemented in hardware or a suitable combination of hardware and software, and may comprise one or more software systems operating on a digital signal processing platform. The “hardware” may comprise a combination of discrete components, an integrated circuit, an application-specific integrated circuit, a field programmable gate array, a digital signal processor, or other suitable hardware. The “software” may comprise one or more objects, agents, threads, lines of code, subroutines, separate software applications, two or more lines of code or other suitable software structures operating in one or more software applications or on one or more processor(s) 202. The processor(s) 202 may include, for example, microprocessors, microcomputers, microcontrollers, digital signal processors, central processing units, state machines, logic circuits, and/or any devices that manipulate signals based on operational instructions. Among other capabilities, the processor(s) 202 may be configured to fetch and execute computer readable instructions in a memory such as a system memory 204 associated with the virtual audio device system 124 for performing tasks such as signal transcoding, input/output data processing, power control, and/or other functions.

In some embodiments, the virtual audio device system 124 may operate as or in an Internet access node, application server, IMS core, service node, or some other communication device or system, including any combination thereof. In some embodiments, the virtual audio device system 124 may comprise or implement one or more real time protocols, e.g., session initiation protocol (SIP), H.261, H.263, H.264, H.323, among others. In some other embodiments, the virtual audio device system 124 may be integrated with or implemented as a set of instructions in a portable storage device; a wearable device such as a fashion accessory (e.g., a wrist band, a ring, etc.) and a body clothing; a utility device (a hand-held baton, a pen, an umbrella, a watch, etc.); or any combination thereof.

The virtual audio device system 124 may include a variety of known, related art, or later developed interface(s) 206, including software interfaces (e.g., an application programming interface, a graphical user interface, etc.); hardware interfaces (e.g., cable connectors, the keyboard, an interactive display screen, etc.); or both. In one embodiment, the virtual audio device system 124 may be in communication or integrated with the adaptor 120 interfacing with the mobile communication device 104.

The virtual audio device system 124 may further include the system memory 204 for storing at least one of (1) details of interfaces (e.g., addresses, compatible protocol, interface type, etc.) in communication with networked audio devices; (2) a log of profiles of network devices and associated compatibility communications including instructions, queries, conversations, data, and related metadata; and (3) logical representations of the network devices and software applications such as the UC application 114.

The system memory 204 may comprise of any computer-readable medium known in the art, related art, or developed later including, for example, a processor or multiple processors operatively connected together, volatile memory (e.g., RAM), non-volatile memory (e.g., flash, etc.), disk drive, etc., or any combination thereof. The system memory 204 may include one or more databases such as a database 208, which may be sub-divided into further databases for storing electronic files and data such as audio or video data. The system memory 204 may have one of many database schemas known in the art, related art, or developed later for storing data from the host device 108, the mobile communication device 104, or the AC endpoint 106 via the virtual audio device system 124. For example, the database 208 may have a relational database schema involving a primary key attribute and one or more secondary attributes. In some embodiments, the virtual audio device system 124 may perform one or more operations, but not limited to, reading, writing, indexing, labeling, updating, and modifying the data, and may communicate with various networked devices.

In one embodiment, the system memory 204 may include various modules such as a virtual audio device stack 210 including multiple virtual input audio cables and virtual output audio cables. The virtual audio device stack 210 may be configured to receive and send audio data streams in various real-time or non-real time communication protocols such as those mentioned above. For example, the virtual audio device stack 210 may receive a first set of audio data streams as Bluetooth signals (hereinafter referred to as BT signals) via the adaptor 120 from the mobile communication device 104 over the network 122; a second set of audio data streams (hereinafter referred to as USB signals) via the second USB port 110 from the AC endpoint 106; and a third set of audio data streams (hereinafter referred to as UC signals) from the UC application 114 being executed by the host device 108.

The virtual audio device stack 210 may determine various characteristics of the interfaces in communication with physical or virtual devices such as the AC endpoint 106, the mobile communication device 104, and the UC application 114 for handling the respective received audio data streams. The characteristics may include, but are not limited to, type (e.g., PCI interface, USB port, etc.) of the interface, supported audio bit rate, supported codecs, network connection speed, and so on.

In some embodiments, the virtual audio device stack 210 may be an interface between the USB port 118 and the adaptor 120 via the USB port 116, e.g., upon determining the attached devices being active, to create an audio bridge or communication channel between the USB port 118 and the adaptor 120 for audio data communication. For example, the virtual audio device stack 210 may interface between the USB port 118 and the adaptor 120 upon determining that the mobile communication device 104 is paired with the adaptor 120 over the network 122 and the AC endpoint 106 being connected to the USB port 118. In another embodiment, the virtual audio device stack 210 may interface the UC application 114 with both the second USB port 118 and the adaptor 120 via the first USB port 116 upon determining the second USB port 118 and the adaptor 120 being active to create an audio channel for audio data communications.

In a further embodiment, the virtual audio device stack 210 may combine audio data streams from multiple audio sources such as at least two of the mobile communication device 104, the AC endpoint 106, and the UC application 114 to create a composite audio data stream for transmission to at least one of the remaining coupled devices. For example, the virtual audio device stack 210 may combine the BT signals and the UC signals to create a composite audio data stream for transmission to the AC endpoint 106 via the second USB port 118. Any of these received audio data streams may be encoded using a variety of encoding algorithms known in the art, related art, or developed later. In some embodiments, the virtual audio device stack 210 may decode these encoded BT signals, the USB signals, and the UC signals for combining at least two of them to create the composite audio data stream. Other embodiments may involve the virtual audio device stack 210 configured to convert the BT signals, the USB signals, and the UC signals into corresponding data packets, namely, BT packets, USB packets, and UC packets in accordance with, for example, the TCP/IP Specification and H.323 Specification.

In some embodiments, the virtual audio device stack 210 may convert the received audio data streams into an appropriate format that may be compatible with one or more external audio devices. For example, the virtual audio device stack 210 may convert the UC signals into, e.g., Bluetooth compatible signals for being communicated to the mobile communication device 104 via the adaptor 120, and vice versa. Similarly, the virtual audio device stack 210 may convert the USB signals into an appropriate format for being played by the host speaker in communication with the UC application 114 executed by the host device 108, and vice versa.

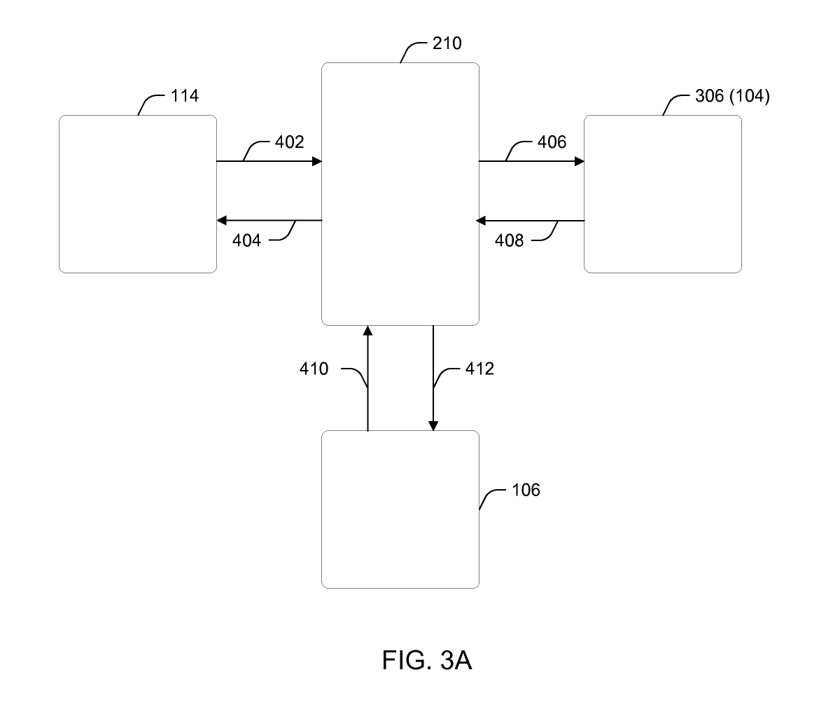

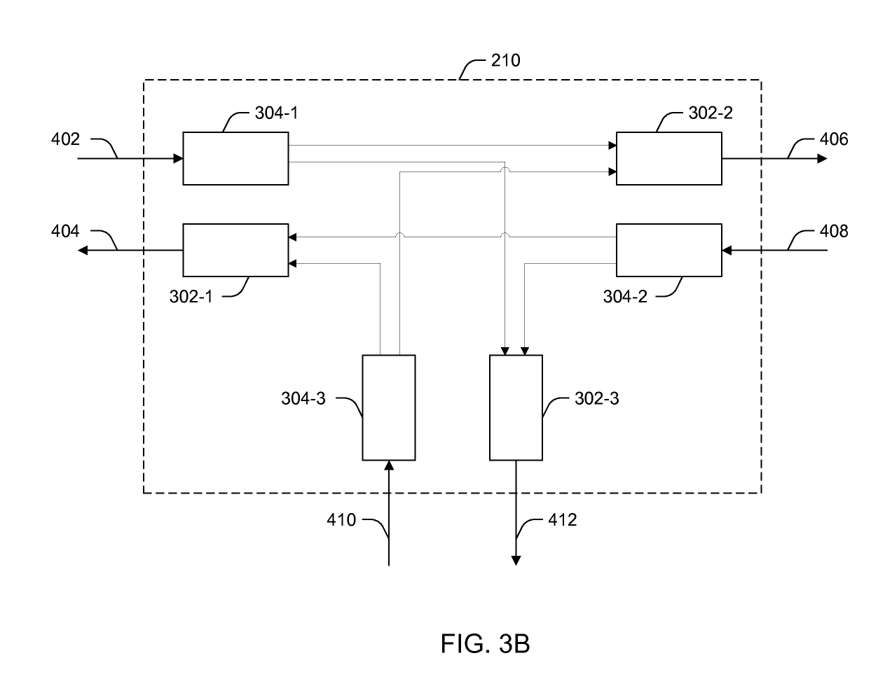

FIGS. 3A and 3B illustrate an exemplary virtual audio device stack 210 implemented by the virtual audio device system of FIG. 1A, according to an embodiment of the present disclosure. The virtual audio device system 124 may be implemented by a software application that operates as the conference application (not shown) being executed on the host device 108 to control or manage the virtual audio device system 124. The conference application may dynamically control various attributes of the virtual audio device system 124 including installation and deletion of virtual audio device stack 210. Other examples of these attributes may include, but not limited to, on-the-fly mapping of a software audio source such as the UC application 114 to multiple audio devices via respective interfaces, dynamic selection of communication protocols and output formats of the audio data streams for transmission, and customized selection of input audio sources and compatible destination devices.

FIG. 3A illustrates one embodiment of the present disclosure. UC application 114 is in communication with the virtual audio stack 210 with an input audio data stream 404 and an output audio data stream 402. A logical representation 306 of the mobile communication device 104 is in communication with the virtual audio stack 210 is in communication with an input audio data stream 406 and an output audio data stream 408. An AC endpoint 106 is in communication with the virtual audio stack 210 with an input audio data stream 412 and an output audio data stream 410.

In FIG. 3B, the virtual audio device stack 210 may include virtual input audio cables 302-1, 302-2, 302-3 (collectively, virtual input audio cables 302) and virtual output audio cables 304-1, 304-2, 304-3 (collectively, virtual output audio cables 304). The conference application may be preconfigured or dynamically configured, e.g., by a user, to operate the virtual audio device system 124 for mapping the virtual input audio cable 302-1 and the virtual output audio cable 304-1 to the UC application 114, where virtual input audio cable 302-1 is in communication with input audio data stream 404 and virtual output cable 304-1 is in communication with output audio data stream 402. Similarly, the conference application may be preconfigured or dynamically configured to the virtual audio device system 124 for mapping the virtual input audio cable 302-2 and the virtual output audio cable 304-2 to a logical representation 306 of the mobile communication device 104, where virtual input audio cable 302-2 is in communication with input audio data stream 406 and virtual output cable 304-2 is in communication with output audio data stream 408. Further, the conference application may be preconfigured or dynamically configured to the virtual audio device system 124 for mapping the virtual input audio cable 302-3 and the virtual output audio cable 304-3 to the AC 106, where virtual input audio cable 302-3 is in communication with input audio data stream 412 and virtual output cable 304-3 is in communication with output audio data stream 410.

The logical mobile device 306 may represent a real time interactive image of the physical mobile communication device 104 and interacts with other devices via the interfaces such as the first USB port 116 and the adaptor 120. The logical mobile device 306 may also facilitate to manage communication with the corresponding external device such as the physical mobile communication device 104 by the host device 108 of the UC system 102.

The virtual input audio cable 302-1 may receive a composite input audio data stream from (i) the virtual audio output cable 304-3 mapped to the output audio data stream 410 that is in communication with a physical microphone (not shown) of the AC endpoint 106 and (ii) the virtual output audio cable 304-2 mapped the output audio data stream 408 that is in communication with a physical microphone (not shown) of the mobile communication device 104. The virtual output audio cable 304-1 may be coupled to multiple devices such that a composite audio data stream may be transmitted to (i) the virtual audio output cable 302-3 mapped to the output audio data stream 412 that is in communication with a physical speaker (not shown) of the AC endpoint 106 and (ii) the virtual output audio cable 302-2 mapped to the output audio data stream 406 that is in communication with a physical speaker (not shown) of the mobile communication device 104 via the logical mobile device 306.

The virtual input audio cable 302-2 may receive a composite input audio data stream from (i) the virtual audio output cable 304-3 mapped to the output audio data stream 410 that is in communication with a physical microphone (not shown) of the AC endpoint 106 and (ii) the virtual output audio cable 304-1 mapped to the output audio data stream 402 that is in communication with the UC application 114. The virtual output audio cable 304-2 may be coupled to multiple devices such that a composite audio data stream may be transmitted to (i) the virtual audio output cable 302-3 mapped to the output audio data stream 412 that is in communication with a physical speaker (not shown) of the AC endpoint 106 and (ii) the virtual output audio cable 302-1 mapped the output audio data stream 404 that is in communication with the UC application 114.

The virtual input audio cable 302-3 may receive a composite input audio data stream from (i) the virtual audio output cable 304-1 mapped to the output audio data stream 402 that is in communication with the UC application 114 and (ii) the virtual output audio cable 304-2 mapped the output audio data stream 408 that is in communication with a physical microphone (not shown) of the mobile communication device 104. The virtual output audio cable 304-3 may be coupled to multiple devices such that a composite audio data stream may be transmitted to (i) the virtual audio output cable 302-1 mapped to the output audio data stream 404 that is in communication with the UC application 114 and (ii) the virtual output audio cable 302-2 mapped the output audio data stream 406 that is in communication with a physical speaker (not shown) of the mobile communication device 104 via the logical mobile device 306.

When a specific external hardware device, such as the mobile communication device 104 or the AC endpoint 106, is connected to the host device 108, the conference application may be preconfigured or dynamically configured to detect such connection and automatically link the corresponding virtual audio device stack 210 to the respective software element such as the UC application 114 and the logical mobile device 306. Similarly, when the external hardware device is disconnected from the host device 108, the conference application may detect such disconnection and automatically disassociate the corresponding virtual audio device stack 210 from the respective software element, thereby avoiding audio data streams from being suddenly disrupted or disabled.

Also during such disconnection, the respective virtual audio device stack 210 may be disabled and the corresponding software element may be configured to use a speaker and a microphone that are set as default by the user. For example, the host speaker 112 and host microphone 110 may be preset as default hardware using the conference application by the user. When the AC endpoint 106 is removed or disconnected from the host device 108, the virtual audio device system 124 may be configured to disable the corresponding audio driver such that the virtual output audio cable 304-1 may transmit the audio data streams generated by the UC application 114 to the virtual input audio cable 302-2 and the host speaker 112 as default speaker instead of the AC endpoint speaker 310. Similarly, the virtual input audio cable 302-1 may be configured to receive audio data streams from the virtual output audio cable 304-2 and the host microphone 110 as the default microphone, instead of the AC endpoint microphone 308, and so on.

Therefore, the virtual audio device system 124, in communication with the conference application, may allow software elements such as the UC application 114 to transmit single or multiple/composite audio data streams to multiple external audio devices such as the mobile communication device 104 and the AC endpoint 106.

Another embodiment illustrates the flexibility of this disclosure. Referring back to FIG. 3A, the virtual audio device stack 210 can provide a 3 way bridged audio call between the UC application 114, the mobile communication device 104, and the AC endpoint 106. The conference application can provide a mix-minus audio bridging mechanism of the audio data streams between all call participants in this embodiment. If the UC application 114 is not currently in use, then the conference application can route the appropriate audio data streams between the mobile communication device 104 and the AC endpoint 106. If a UC application 114 call becomes active after the mobile communication device 104 is enabled, then audio data stream is combined into a composite audio data stream from all three sources. The same process applies to the case where a UC application 114 call is in process. When the mobile communication device is joined to the call, the audio data stream is combined into a composite audio data stream of from all three sources.

To summarize, this disclosure describes a system that uses a virtual audio device system for unified communications (UC) applications between a host device and a plurality of audio devices. The system comprises a host device, a plurality of audio devices, and a virtual audio device system. The host device executes a UC application to generate a first audio data stream, wherein the host device is in communication with a microphone and a speaker. The plurality of audio devices receives the first audio data stream generated by the host device, wherein each of the plurality of audio devices is capable of generating its own additional audio data stream. The virtual audio device system establishes a communication channel between the UC application and the plurality of audio devices based on the plurality of audio devices connected to the host device. The virtual audio device system is configured to combine the first audio data stream and the additional audio data streams to create a composite audio data stream.

Another embodiment of this disclosure provides that the virtual audio device system dynamically adjusts the combining of the audio data streams into the composite audio data stream according to the absence or presence of the UC application and the plurality of audio devices connected to the host device.

Another embodiment of this disclosure provides that the plurality of audio devices comprise at least one of a mobile communication device and a speakerphone.

Another embodiment of this disclosure provides that the virtual audio device system is implemented as a device driver.

Another embodiment of this disclosure provides that the virtual audio device system is dynamically managed by a predefined software application such as a conference application, which controls the microphone and the speaker as default devices upon request.

Other embodiments of the present invention will be apparent to those ordinarily skilled in the art after considering this disclosure or practicing the disclosed invention. The specification and examples above are exemplary only, with the true scope of the present invention being determined by the following claims.

1. A system that uses a virtual audio device system for unified communications (UC) applications between a host device and a plurality of audio devices, comprising:
a host device that executes a Unified Communications (UC) application to generate a first audio data stream, wherein said host device is in communication with a microphone and a speaker;
a plurality of audio devices that receives said first audio data stream generated by said host device, wherein each of said plurality of audio devices is capable of generating its own additional audio data stream; and
a virtual audio device system that establishes a communication channel between said UC application and said plurality of audio devices based on said plurality of audio devices connected to said host device, wherein said virtual audio device system is configured to combine said first audio data stream and said plurality of additional audio data streams to create a composite audio data stream.

2. The claim according to claim 1, wherein said virtual audio device system dynamically adjusts the combining of said audio data streams into said composite audio data stream according to the absence or presence of said UC application and said plurality of audio devices connected to said host device.

3. The claim according to claim 1, wherein said plurality of audio devices comprise at least one of a mobile communication device and a speakerphone.

4. The claim according to claim 1, wherein said virtual audio device system is implemented as a device driver.

5. The claim according to claim 1, wherein said virtual audio device system is dynamically managed by a predefined software application, which controls said microphone and said speaker as default devices upon request.

6. A method to use a system that uses a virtual audio device system for unified communications (UC) applications between a host device and a plurality of audio devices, comprising:
executing a Unified Communications (UC) application on a host device to generate a first audio data stream, wherein said host device is in communication with a microphone and a speaker;
receiving said first audio data stream generated by said host device using a plurality of audio devices, wherein each of said plurality of audio devices is capable of generating its own additional audio data stream; and
establishing a communication channel between said UC application and said plurality of audio devices using a virtual audio device system, wherein said communication channel is established based on said plurality of audio devices connected to said host device, wherein said virtual audio device system is configured to combine said first audio data stream and said plurality of additional audio data streams to create a composite audio data stream.

7. The claim according to claim 6, wherein said virtual audio device system dynamically adjusts the combining of said audio data streams into said composite audio data stream according to the absence or presence of said UC application and said plurality of audio devices connected to said host device.

8. The claim according to claim 6, wherein said plurality of audio devices comprise at least one of a mobile communication device and a speakerphone.

9. The claim according to claim 6, wherein said virtual audio device system is implemented as a device driver.

10. The claim according to claim 6, wherein said virtual audio device system is dynamically managed by a predefined software application, which controls said microphone and said speaker as default devices upon request.

11. A method to manufacture a that uses a virtual audio device system for unified communications (UC) applications between a host device and a plurality of audio devices, comprising:
providing a host device configured to execute a Unified Communications (UC) application to generate a first audio data stream, wherein said host device is in communication with a microphone and a speaker;
providing a plurality of audio devices for receiving said first audio data stream generated by said host device, wherein each of said plurality of audio devices is capable of generating its own additional audio data stream; and
providing a virtual audio device system configured to establish a communication channel between said UC application and said plurality of audio devices based on said plurality of audio devices connected to said host device, wherein said virtual audio device system is configured to combine said first audio data stream and said plurality of additional audio data streams to create a composite audio data stream.

12. The claim according to claim 11, wherein said virtual audio device system dynamically adjusts the combining of said audio data streams into said composite audio data stream according to the absence or presence of said UC application and said plurality of audio devices connected to said host device.

13. The claim according to claim 11, wherein said plurality of audio devices comprise at least one of a mobile communication device and a speakerphone.

14. The claim according to claim 11, wherein said virtual audio device system is implemented as a device driver.

15. The claim according to claim 11, wherein said virtual audio device system is dynamically managed by a predefined software application, which controls said microphone and said speaker as default devices upon request.

16. A non-transitory program storage device readable by a computing device that tangibly embodies a program of instructions executable by said computing device to perform a method to use a system that uses a virtual audio device system for unified communications (UC) applications between a host device and a plurality of audio devices, comprising:
executing a Unified Communications (UC) application on a host device to generate a first audio data stream, wherein said host device is in communication with a microphone and a speaker;
receiving said first audio data stream generated by said host device using a plurality of audio devices, wherein each of said plurality of audio devices is capable of generating its own additional audio data stream; and
establishing a communication channel between said UC application and said plurality of audio devices using a virtual audio device system, wherein said communication channel is established based on said plurality of audio devices connected to said host device, wherein said virtual audio device system is configured to combine said first audio data stream and said plurality of additional audio data streams to create a composite audio data stream.

17. The claim according to claim 16, wherein said virtual audio device system dynamically adjusts the combining of said audio data streams into said composite audio data stream according to the absence or presence of said UC application and said plurality of audio devices connected to said host device.

18. The claim according to claim 16, wherein said plurality of audio devices comprise at least one of a mobile communication device and a speakerphone.

19. The claim according to claim 16, wherein said virtual audio device system is implemented as a device driver.

20. The claim according to claim 16, wherein said virtual audio device system is dynamically managed by a predefined software application, which controls said microphone and said speaker as default devices upon request.
